(19) United States
(12) Patent Application Publication
(10) Pub. No.: US 2021/0215946 A1
(43) Pub. Date: Jul. 15, 2021

(54) LENS APPARATUS, IMAGE PICKUP APPARATUS, AND IMAGE PICKUP SYSTEM

(71) Applicant: CANON KABUSHIKI KAISHA, Tokyo (JP)

(72) Inventor: Katsumi Ohmori, Tochigi (JP)

(21) Appl. No.: 17/146,750

(22) Filed: Jan. 12, 2021

(30) Foreign Application Priority Data
Jan. 15, 2020 (JP) 2020-004426

(51) Int. Cl. G02B 27/64; G02B 7/02; G02B 7/08; G03B 5/06

(52) U.S. Cl. CPC G02B 27/646; G02B 7/023; G03B 2205/0015; G03B 5/06; G02B 7/08

(57) ABSTRACT

Provided is a lens apparatus including: a movable frame configured to hold a lens; driving coils configured to move the movable frame during image blur correction; a guide barrel which is made of a non-magnetic conductive material, and is configured to support the driving coils; and a horizontal stripe noise reducing plate including: a flat surface portion located on one side of the driving coils in a direction of an optical axis of the lens; and an extending portion located on one side of each of the driving coils in a direction perpendicular to the optical axis, wherein the guide barrel is adjacent to the driving coils on another side of the driving coils in the direction perpendicular to the optical axis.

### BACKGROUND OF THE INVENTION

### Field of the Invention

The present disclosure relates to a lens apparatus, and an image pickup apparatus and an image pickup system using the lens apparatus.

### Description of the Related Art

There is known a lens apparatus configured to move an optical element to perform image blur correction. When the lens apparatus is attached to an image pickup apparatus, noise may occur in an image generated by an image pickup element due to variation in magnetic field caused by the lens apparatus.

In Japanese Patent Application Laid-Open No. 2015-169883, there is disclosed a technology of suppressing the noise occurrence in the image by stopping drive of an optical element for image blur correction while electric charges in an image pickup element are read.

### SUMMARY OF THE INVENTION

However, when the drive of the optical element is stopped as in Japanese Patent Application Laid-Open No. 2015-169883, a position of the optical element is changed due to its own weight, and hence it is required to correct the position of the optical element after the reading of the electric charges is completed. Meanwhile, when the optical element is driven for the image blur correction also while the electric charges are read, the noise is superimposed on the image to reduce image quality.

It is an object of the present disclosure to provide a lens apparatus capable of suppressing occurrence of noise in an image during image blur correction, and maintaining a position of an optical element, and an image pickup apparatus and an image pickup system using the lens apparatus.

In order to achieve the above-mentioned object, there is provided a lens apparatus including: a holding member configured to hold an optical element; coils configured to move the holding member during image blur correction; a supporting member which is made of a non-magnetic conductive material, and is configured to support the coils; and a non-magnetic conductive member including: a first portion located on one side of the coils in a direction of an optical axis of the optical element; and a second portion located on one side of each of the coils in a direction perpendicular to the optical axis, wherein the supporting member is adjacent to the coils on another side of the coils in the direction perpendicular to the optical axis.

The lens apparatus capable of suppressing occurrence of noise in the image during image blur correction, and maintaining the position of the optical element, and the image pickup apparatus and the image pickup system using the lens apparatus can be provided.

Further features of the present invention will become apparent from the following description of exemplary embodiments with reference to the attached drawings.

### BRIEF DESCRIPTION OF THE DRAWINGS

FIG. 1A is a cross-sectional view of a lens apparatus (110) according to a first embodiment. FIG. 1B is a cross-sectional view of a main part.

FIG. 2 is an exploded perspective view of an image blur correction device (30) in the first embodiment.

FIG. 3A and FIG. 3B are graphs for showing PWM driving in the first embodiment.

FIG. 4A is a schematic diagram of a magnetic field generated by a driving coil (35) in the first embodiment. FIG. 4B is a schematic diagram of a horizontal stripe noise reducing plate (46), a part of a guide barrel (10), and the magnetic field generated by the driving coil (35).

FIG. 5 is a front view of the horizontal stripe noise reducing plate (46) in the first embodiment.

FIG. 6A is a configuration view of an image blur correction device (230) in a second embodiment. FIG. 6B is a perspective view of a main part of the image blur correction device (230).

FIG. 7 is a configuration view of an image pickup apparatus (100) to which the present disclosure is applied.

FIG. 8 is a block diagram of the image pickup apparatus (100) to which the present disclosure is applied.

### DESCRIPTION OF THE EMBODIMENTS

### First Embodiment

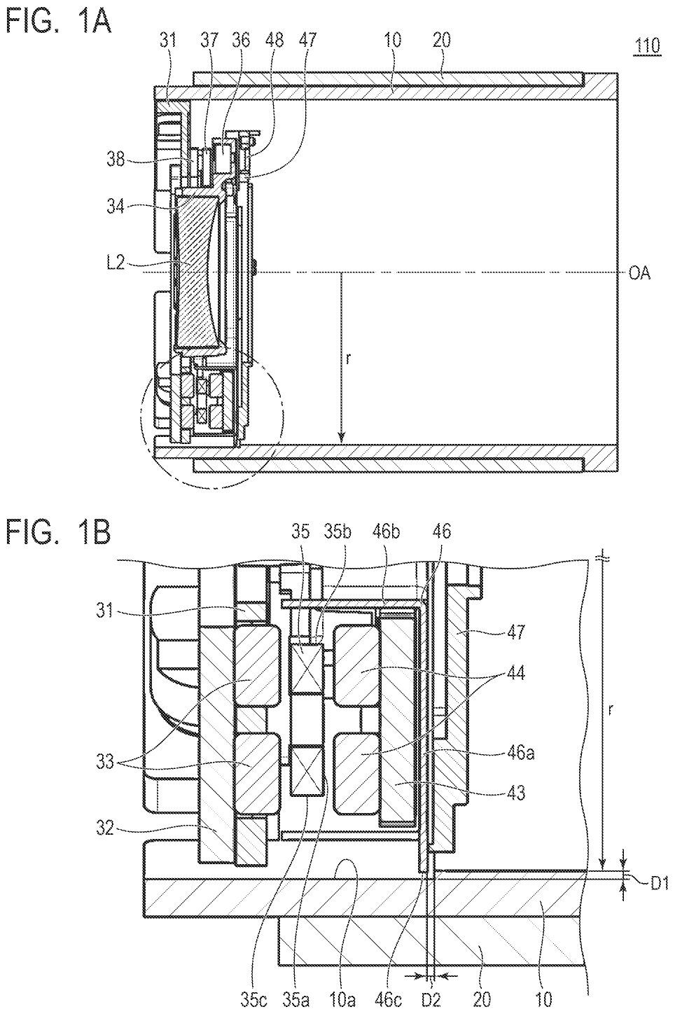

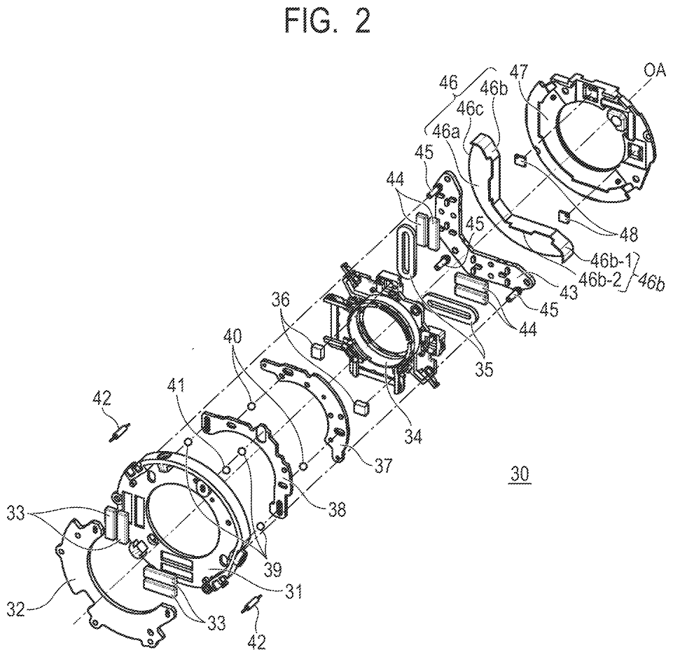

Preferred embodiments of the present invention will now be described in detail in accordance with the accompanying drawings. A lens apparatus 110 according to a first embodiment of the present disclosure is described. FIG. 1A is a cross-sectional view of the lens apparatus 110, and FIG. 1B is a cross-sectional view of a main part of a region encircled in FIG. 1A. FIG. 2 is an exploded perspective view of an image blur correction device 30 included in the lens apparatus 110. The lens apparatus 110 is an interchangeable lens to be detachably attached to an image pickup apparatus 100.

The lens apparatus 110 includes a guide barrel 10 (supporting member) and a cam ring 20. The guide barrel 10 is configured to support an imaging optical system 1 to be described later. The lens apparatus 110 moves a part of the imaging optical system 1 in a direction of an optical axis OA with a guide groove (not shown) formed in the guide barrel 10 and a cam groove (not shown) formed in the cam ring 20, thereby being capable of varying a magnification. Each of the guide barrel 10 and the cam ring 20 is a member made of an aluminum alloy, which is a non-magnetic conductive material. The guide barrel 10 is configured to support the image blur correction device 30 illustrated in FIG. 2. The image blur correction device 30 is configured not to move (is fixed) at the time of varying the magnification and adjusting a focus.

Next, a configuration of the image blur correction device 30 is described. A first yoke 32 made of a magnetic material is fixed with screws to a fixing frame 31 (fixing member) supported by the guide barrel 10 via rollers (not shown). First driving magnets 33 are inserted through openings formed in the fixing frame 31 are firmly fixed to the first yoke 32 through magnetic attraction. The first driving magnets 33 are permanent magnets (magnets) formed of neodymium magnets. A movable frame 34 (holding member), which is supported in such a manner as to be movable with respect to the fixing frame 31, is configured to hold a lens L2, which is an optical element and forms a part of the imaging optical system 1. The lens L2 is moved in a plane orthogonal to the optical axis OA to perform what is called image blur correction (camera shake correction). During the image blur correction, it is not necessarily required to move the lens L2 in a direction perpendicular to the optical axis OA, and it is only required to move the lens L2 in a direction containing a component perpendicular to the optical axis OA.

Two driving coils 35 and two magnets 36 for position detection are fixed to the movable frame 34. A first guide plate 37 is further fixed to the movable frame 34 with screws. A second guide plate 38 is supported with respect to the fixing frame 31 via first rolling balls 39 in such a manner as to be movable in a longitudinal direction in the plane orthogonal to the optical axis OA. The movable frame 34, to which the first guide plate 37 is fixed, is supported with respect to the second guide plate 38 via second rolling balls 40 in such a manner as to be movable in a lateral direction in the plane orthogonal to the optical axis OA. Further, the movable frame 34 is supported with respect to the fixing frame 31 via third rolling balls 41 in such a manner as to be movable in the direction orthogonal to the optical axis OA. The movable frame 34 is always urged against the fixing frame 31 by tension coil springs 42. With the above-mentioned configuration, the movable frame 34 is movable in the plane orthogonal to the optical axis OA.

Second driving magnets 44 are positioned on a second yoke 43 by projections formed on the second yoke 43, and are firmly fixed through magnetic attraction. The second driving magnets 44 are, as with the first driving magnets 33, permanent magnets formed of neodymium magnets. The second yoke 43 is firmly fixed to the first yoke 32 in such a manner as to sandwich support columns 45, which are a part of a support unit, by a magnetic attraction force generated between the first driving magnets 33 and the second driving magnets 44.

As illustrated in FIG. 1B, the driving coils 35 are fixed to the movable frame 34 such that the driving coils 35 are located in a gap between the first driving magnets 33 and the second driving magnets 44. Across the driving coils 35, the first yoke 32 and the first driving magnets 33 form a magnetic circuit on an object side, and the second yoke 43 and the second driving magnets 44 form a magnetic circuit on an image plane side.

A horizontal stripe noise reducing plate 46 (non-magnetic conductive member), which is a magnetic field variation reducing unit, is fixed to the second yoke 43 with double-sided tape. The horizontal stripe noise reducing plate 46 is made of copper, which is a non-magnetic conductive material. An action thereof is to be described later.

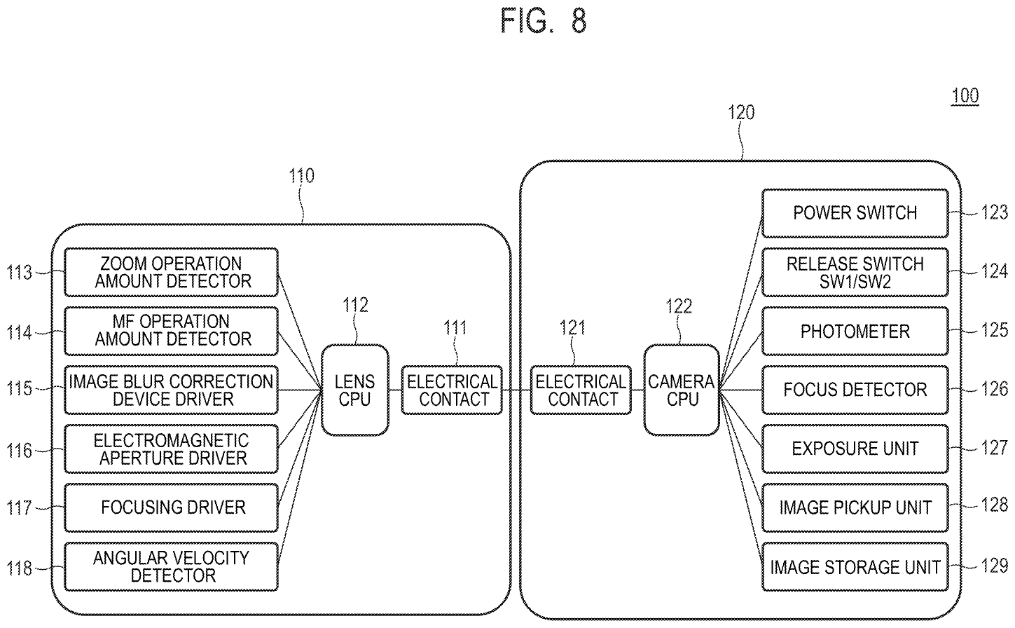

A flexible substrate (not shown) having mounted thereon a Hall sensor 48 for position detection is fixed to a sensor holding member 47, and the sensor holding member 47 is fixed to the fixing frame 31 with screws. Further, terminal portions of the driving coils 35 are electrically connected to the flexible substrate by soldering. The flexible substrate is connected to an electric circuit board (not shown). On the electric circuit board, a control circuit (lens CPU 112, see FIG. 8) configured to control operation of the lens apparatus 110 and perform various arithmetic computations is mounted.

Next, operation of the image blur correction device 30 is described. As a drive unit for the image blur correction device 30, a voice coil motor (hereinafter referred to as “VCM”) is used. The VCM utilizes magnetic interaction between lines of magnetic force generated around the driving coils 35 by an electric current I flowing therethrough, and lines of magnetic force generated by the permanent magnets (first driving magnets 33 and second driving magnets 44) forming the magnetic circuits in the gap in which the driving coils 35 are arranged. The VCM is configured to generate a driving force by a Lorentz force caused by those lines of magnetic force.

As described above, the Lorentz force is generated when the driving coils 35 are energized, and the movable frame 34 is moved in the plane orthogonal to the optical axis OA. Two sets of the driving coils 35, the first driving magnets 33, and the second driving magnets 44 are arranged in two directions that are orthogonal to each other. Therefore, the movable frame 34 can move freely in a predetermined range in the plane orthogonal to the optical axis OA by synthesis of driving forces in those two directions.

The Hall sensor 48 is configured to convert a magnetic flux density of the magnets 36 for position detection into an electric signal. With the Hall sensor 48, a relative position of the movable frame 34 with respect to the fixing frame 31 is detected. Based on the detection, the movable frame 34 holding the lens L2 can be moved to a desired position, and hence image blur caused by camera shake, for example, can be prevented.

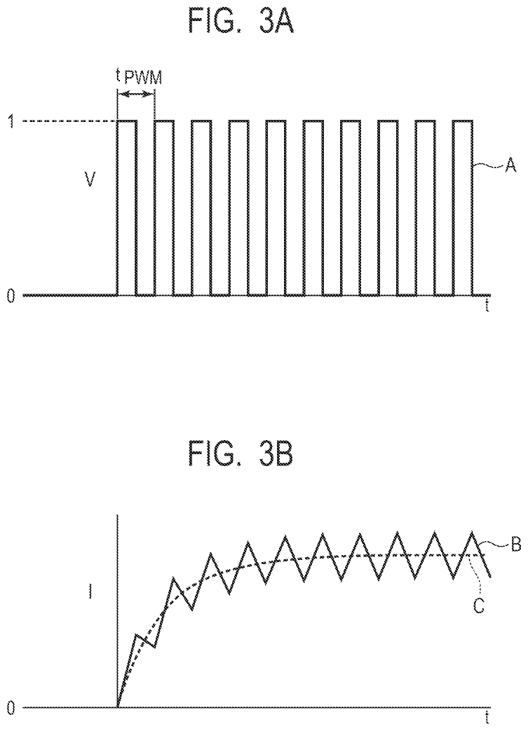

FIG. 3A and FIG. 3B are graphs for showing a voltage V applied when the driving coils 35 are driven by pulse width modulation (hereinafter referred to as “PWM driving”) and the electric current I. FIG. 3A shows the voltage V applied to the driving coils 35, and FIG. 3B shows the electric current I flowing through the driving coils 35. The horizontal axis indicates time “t” shown at equal intervals. In the PWM driving, with the voltage V being repeatedly turned ON and OFF to have a desired pulse width, the electric current I flowing through the driving coils 35 is set to a desired value in time average to drive a driving target. The PWM driving has features of convenience in driving by a microcomputer and low power consumption, and is often used for power saving in mobile devices using a battery as a power source.

FIG. 3A shows a voltage waveform A used in the PWM driving, with “0” being 0 V, and “1” being a normalized maximum voltage that can be used. Further, the time “t” of one cycle of the PWM driving is expressed by a time width t_{P W M}. In one cycle, proportions in time of “1” and “0” are in a state of half and half, and this case is referred to as a “50% duty”. In FIG. 3B, the electric current I flowing through the driving coils 35 when the voltage V having the voltage waveform A is applied is shown as a current value B, which is shown to have a large change in current for the purpose of description. Further, in FIG. 3B, a current value C exhibiting a smooth change is indicated by the broken line, which shows the electric current I flowing through the driving coils 35 when a voltage having a normalized value of “0.5” is applied continuously from a state in which a voltage is 0 V. The current value C rises obliquely due to the effect of an inductance of the driving coils 35.

When a predetermined period of time has elapsed under application of the voltage V, and the voltage waveform A is brought into a steady state, the current value C and the time average value of the current value B in the PWM driving become the same. In other words, the proportions in time (duty cycle) of “1” and “0” can be changed to control the time average value of the current value B. Here, the fact that the electric current I flowing through the driving coils 35 fluctuates with a driving frequency of the PWM driving means that a thrust generated by the VCM fluctuates similarly. It should be noted, however, that because a driven body that is driven by the VCM has a mass, a displacement in response to the applied thrust becomes smaller as the frequency of the fluctuation in generated thrust becomes higher. In other words, the driving frequency of the PWM driving is set high as appropriate depending on the mass of the driven body to substantially eliminate the effect of the fluctuation in generated thrust. However, a magnetic field generated around the driving coils 35 by the electric current I flowing through the driving coils 35 fluctuates in intensity depending on a change in current value in the PWM driving.

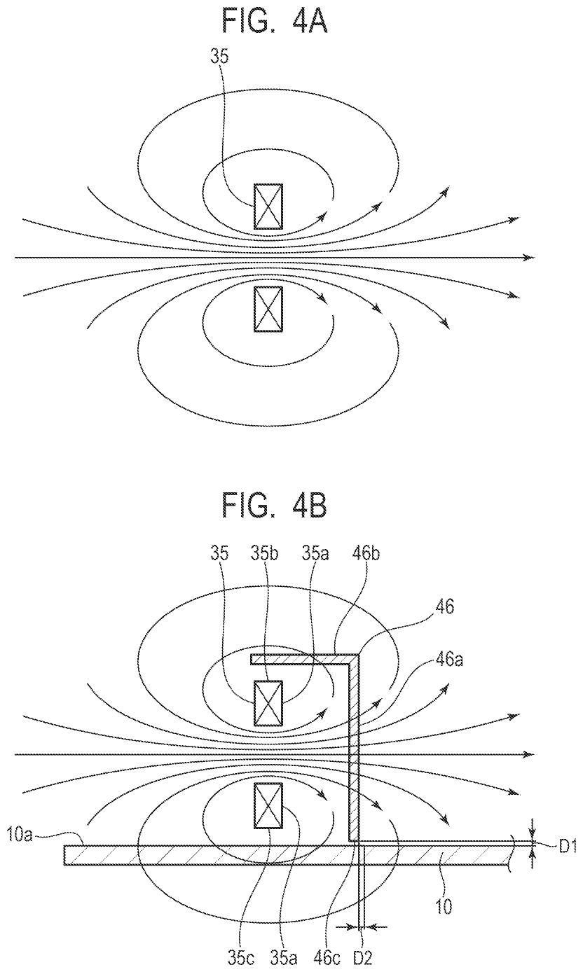

FIG. 4A is a schematic diagram for illustrating the magnetic field generated by the driving coil 35 in the first embodiment, and is illustrated in the same direction as the cross-sectional view of FIG. 1A, that is, with the right side being the image plane side. FIG. 4B shows the horizontal stripe noise reducing plate 46, a part of the guide barrel 10, and the magnetic field generated by the driving coils 35 in the first embodiment.

The lines of magnetic force generated by energization of the driving coil 35 are schematically shown around the driving coil 35, and the arrows indicate directions of the lines of magnetic force. As physical characteristics, lines of magnetic force in the same direction repel each other, and a line of magnetic force is always closed to be as short as possible in a space. Two lines of magnetic force closer to an upper part and a lower part of the main body of the driving coil 35 are expressed as being closed, that is, as being connected endlessly. Five lines of magnetic force near the center between the upper part and the lower part of the driving coil 35 are expressed as having ends for the sake of the space of the drawing sheet, but the ends go all the way around to be connected in reality. FIG. 4A merely shows a cross section, and the magnetic field is generated in a three-dimensional manner in a three-dimensional space in reality. The lines of magnetic force generated by the driving coils 35 have the property of repelling each other, and hence it can easily be imagined that lines of magnetic force spread in a wide range. It should be noted, however, that as the lines of magnetic force spread wider, the magnetic flux density (corresponding to an interval of the lines of magnetic force) becomes lower.

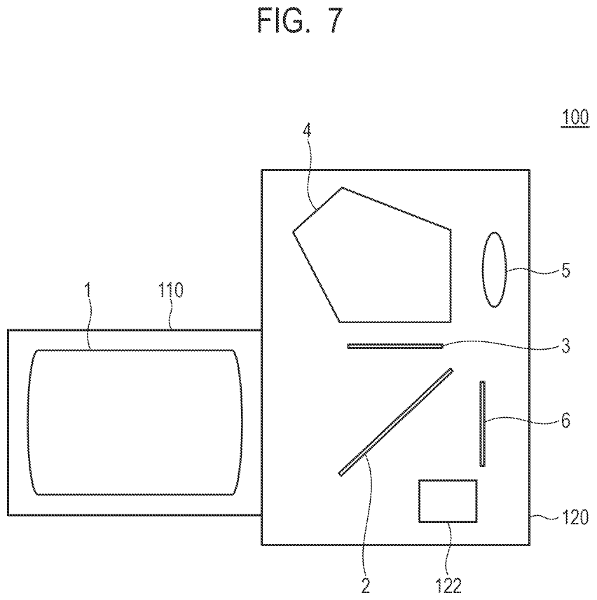

When the driving coil 35 is driven by PWM driving as shown in FIG. 3A, a change in intensity of the magnetic field corresponding to a change in current value is superimposed on each line of magnetic force. A change in current value corresponding to the driving frequency (frequency of repeatedly turning ON/OFF) at which the driving coils 35 are driven by PWM driving remains, and a change in intensity may also remain in the magnetic field generated around the driving coils 35 when the fluctuating electric current I flows therethrough. In recent years, an image pickup element 6 (see FIG. 7) mounted in the image pickup apparatus 100 is increased in sensitivity, and a camera is downsized to reduce a distance between the driving coils 35 and the image pickup element 6, with the result that horizontal stripe noise may occur in an image signal due to the above-mentioned variation in magnetic field.

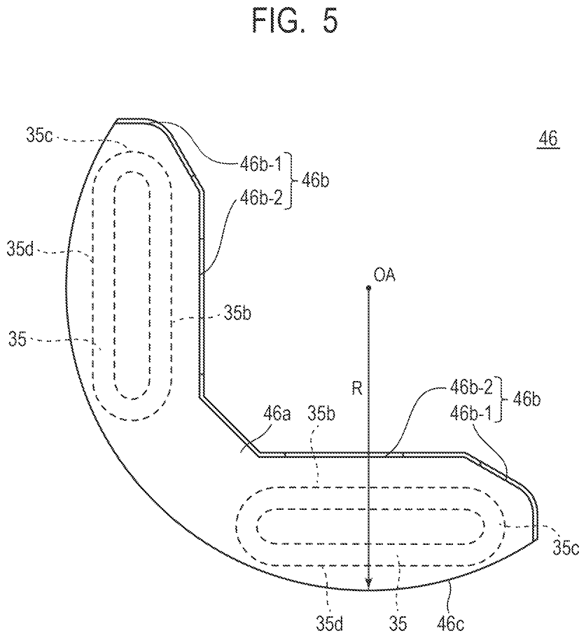

However, in the present disclosure, the horizontal stripe noise reducing plate 46 as the magnetic field variation reducing unit is provided. Next, a configuration of the horizontal stripe noise reducing plate 46 is described. FIG. 5 is a front view of the horizontal stripe noise reducing plate 46 when viewed from the object side, but the two driving coils 35 are schematically indicated by the broken lines for the purpose of description. The horizontal stripe noise reducing plate 46 is formed of a flat surface portion 46a (first portion) and an extending portion 46b (second portion). The flat surface portion 46a is located on one side of the driving coils 35 (image plane side 35a of the driving coils 35, see FIG. 1B) in the direction of the optical axis OA. The extending portion 46b is located on one side of each of the driving coils 35 (lateral side 35b of the driving coil 35) in the direction perpendicular to the optical axis OA. The flat surface portion 46a further includes an arc portion 46c, which has an arc shape having a radius R with the optical axis OA being the center. The extending portion 46b is further formed of a first extending portion 46b-1 located on one side (longitudinal side 35c) of the driving coil 35 in a longitudinal direction thereof, and a second extending portion 46b-2 located on the one side (lateral side 35b) of the driving coil 35 in a lateral direction thereof. Both of the first extending portion 46b-1 and the second extending portion 46b-2 extend on the object side (left side in FIG. 2).

As illustrated in FIG. 4B and FIG. 5, the horizontal stripe noise reducing plate 46 is arranged to cover the image plane side 35a, the lateral side 35b, and the longitudinal side 35c of each of the driving coils 35. The flat surface portion 46a has an area that is larger than a region facing the magnetic circuit formed by the second yoke 43 and the second driving magnets 44, and is located on the image plane side 35a of the driving coils 35. Further, the second extending portion 46b-2 of the extending portion 46b is located on the lateral side 35b of the driving coil 35 that is closer to the optical axis OA. Still further, the first extending portion 46b-1 of the extending portion 46b is located on the longitudinal side 35c of the driving coil 35. In other words, the horizontal stripe noise reducing plate 46 covers the driving coils 35 not only in the radial direction but also in a circumferential direction.

As illustrated in FIG. 1B, the arc portion 46c is located extremely close to an inner peripheral portion of the guide barrel 10, and extends up to a concave portion 10a (step portion) that is recessed radially by one step from an innermost diameter “r” of an inner surface of the guide barrel 10, and the radius R of the arc portion 46c is larger than the innermost diameter “r” of the guide barrel 10. Further, a clearance D1 in the radial direction between the concave portion 10a of the guide barrel 10 and the arc portion 46c of the horizontal stripe noise reducing plate 46, and a clearance D2 in the direction of the optical axis OA are each set to be equal to or smaller than 1 mm. With this configuration, when viewed in the direction of the optical axis OA, a part of the guide barrel 10 and a part (arc portion 46c) of the flat surface portion 46a overlap each other. Still further, in the direction of the optical axis OA, the part of the guide barrel 10 and the part (arc portion 46c) of the flat surface portion 46a face each other with the clearance D2. In other words, another side (outer peripheral side 35d) of each of the driving coils 35 faces the guide barrel 10 (is separated from and adjacent to the guide barrel 10) without being covered by the horizontal stripe noise reducing plate 46, and the driving coils 35 are surrounded by the guide barrel 10 and the horizontal stripe noise reducing plate 46 with only the object side of the driving coils 35 being open. The guide barrel 10 is located on a side opposite to the optical axis OA with respect to the driving coils 35 in the direction perpendicular to the optical axis OA.

Actions and functions of the horizontal stripe noise reducing plate 46 are described. As described above, each of the guide barrel 10 and the horizontal stripe noise reducing plate 46 is made of a non-magnetic conductive material. Therefore, magnetic fields that do not change in intensity do not interact with each other. However, as is well known, in response to magnetic fields that change in intensity, an eddy current flows due to electromagnetic induction, and acts to interfere with the change in intensity. In the first embodiment, as illustrated in FIG. 1B, the driving coils 35 are surrounded by the guide barrel 10 and the horizontal stripe noise reducing plate 46, but only the object side of the driving coils 35 is open. With the configuration in which the arc portion 46c of the horizontal stripe noise reducing plate 46 extends up to the concave portion 10a that is recessed radially by one step from the innermost diameter “r” of the guide barrel 10, clearances (clearances D1 and D2) formed by the horizontal stripe noise reducing plate 46 and the guide barrel 10 are set small. With this configuration, most of lines of magnetic force traveling in a direction toward the image plane side pass through the guide barrel 10 or the horizontal stripe noise reducing plate 46 (see FIG. 4B). Therefore, the change in intensity of the magnetic field superimposed by the PWM driving is inhibited by the passing lines of magnetic force to suppress the occurrence of the horizontal stripe noise. This effect becomes more significant as an electrical conductivity becomes higher. Examples of a metal having a high electrical conductivity include silver, copper, gold, and aluminum, in order of decreasing electrical conductivity, and an alloy containing each of the materials as a base material generally has a lower electrical conductivity. In other words, copper and aluminum are examples of suitable materials.

Further, in the first embodiment, the arc portion 46c is formed in the horizontal stripe noise reducing plate 46, and the arc portion 46c is placed adjacent to the guide barrel 10 with the clearance D1 of 1 mm or less to achieve the configuration in which the driving coils 35 are surrounded by the non-magnetic conductive material. As compared to a shape in which there is an extending portion over the entire periphery along the outer edge of the flat surface portion 46a of the horizontal stripe noise reducing plate 46, the image blur correction device 30 can be downsized in the radial direction. In other words, contribution can be made to the downsizing of the entire lens apparatus 110.

With the horizontal stripe noise reducing plate 46, the occurrence of the horizontal stripe noise caused by the driving of the image blur correction device 30 is suppressed, and hence it is not required to stop driving the image blur correction device 30 even while electric charges in the image pickup element 6 are read. Therefore, the lens apparatus 110 capable of suppressing the reduction in image quality can be provided. Further, there can be provided the excellent effect that the position of the lens L2 can be maintained even while the charges in the image pickup element 6 are read.

### Second Embodiment

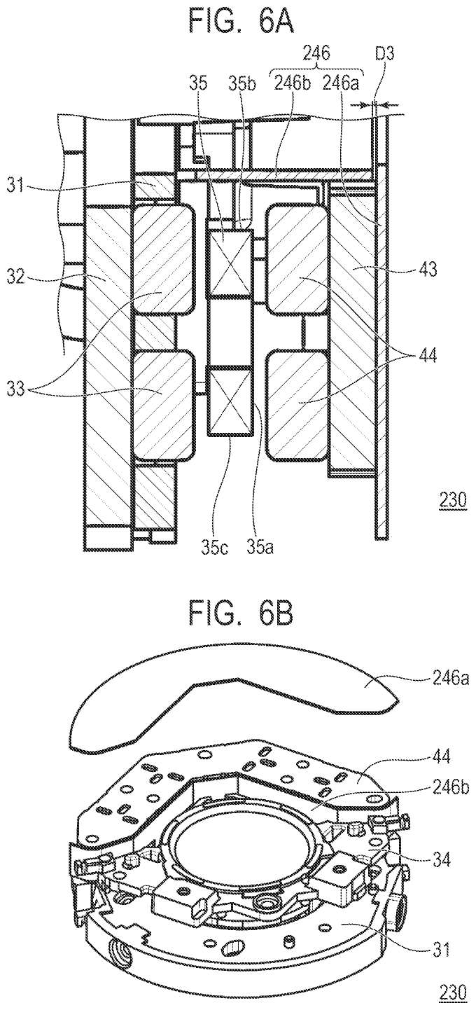

Next, a lens apparatus 110 according to a second embodiment of the present disclosure is described. FIG. 6A is a cross-sectional view of a main part of an image blur correction device 230 in the second embodiment, and FIG. 6B is a perspective view of the image blur correction device 230. A basic configuration of the image blur correction device 230 is the same as that of the image blur correction device 30 in the first embodiment. Therefore, components having common functions or roles to those in the first embodiment are denoted by the same reference symbols as in the first embodiment, and description thereof is omitted.

The horizontal stripe noise reducing plate 46 is integrally formed of one member in the first embodiment, but the second embodiment is different from the first embodiment in that a horizontal stripe noise reducing plate 246 is formed of a plurality of separate members. An advantage of the horizontal stripe noise reducing plate 246 formed of the plurality of members is easiness of producing the members, that is, increased accuracy of the members. When the accuracy of the members is increased, amounts of the clearances secured in the image blur correction device 230 can be reduced, and the product can be further downsized.

The horizontal stripe noise reducing plate 246 is formed of a flat surface member 246a (first portion) located on one side of the driving coils 35 in the direction of the optical axis OA, and an extending member 246b (second portion) located on one side of the driving coils 35 in the direction perpendicular to the optical axis OA. The flat surface portion 46a and the extending portion 46b of the horizontal stripe noise reducing plate 46 in the first embodiment play the same roles as the flat surface member 246a and the extending member 246b, respectively, and each of the flat surface member 246a and the extending member 246b is made of copper, which is a non-magnetic conductive material.

As illustrated in FIG. 6A, the horizontal stripe noise reducing plate 246 is arranged to cover the image plane side 35a, the lateral side 35b closer to the optical axis OA, and the longitudinal side 35c (not shown) of each of the driving coils 35. The flat surface portion 246a has an area that is larger than a region facing the magnetic circuit formed by the second yoke 43 and the second driving magnets 44, and is located on the image plane side 35a of the driving coils 35. Further, the extending portion 246b of the extending portion 46b is located on the lateral side 35b closer to the optical axis OA and the longitudinal side 35c (not shown) of the driving coil 35.

Each of the flat surface member 246a and the extending member 246b is formed by pressing. The extending member 246b is positioned by being inserted into and bonded to holes (not shown) formed in the fixing frame 31. The flat surface member 246a is positioned with respect to the second yoke 43, and fixed by double-sided tape. As illustrated in FIG. 6A, the extending member 246b and the flat surface member 246a are arranged so as to have a clearance D3 of about 0.3 mm in the direction of the optical axis OA. As described above, under a state in which the flat surface member 246a and the extending member 246b are assembled into the image blur correction device 230, the clearance formed by the members is reduced as much as possible, and hence effects on the change in intensity of the magnetic field that are equivalent to the horizontal stripe noise reducing plate 46 described in the first embodiment can be obtained.

### Application Example

With reference to FIG. 7 and FIG. 8, description is given of the image pickup apparatus 100 (image pickup system) to which the first embodiment or the second embodiment is applied. FIG. 7 is a configuration view of the image pickup apparatus 100, and the lens apparatus 110 includes the imaging optical system 1. A camera body 120 (main body of the image pickup apparatus 100) includes a quick return mirror 2, a focusing plate 3, a penta dach prism 4, and an eyepiece 5, for example. The quick return mirror 2 is configured to reflect a light flux formed through the imaging optical system 1 upward. The focusing plate 3 is arranged at an image forming position of the imaging optical system 1. The penta dach prism 4 is configured to convert a reverse image formed on the focusing plate 3 into an erect image. A user can observe the erect image through the eyepiece 5.

The image pickup element 6 is formed of a CCD sensor or a CMOS sensor, and is configured to photoelectrically convert an optical image (object image) formed through the imaging optical system 1 to output image data. During photography, the quick return mirror 2 is allowed to retreat from an optical path, and an optical image is formed on the image pickup element 6 through the imaging optical system 1. A camera CPU 122 (controller) is configured to control operation of the components of the image pickup apparatus 100.

FIG. 8 shows a block configuration of the image pickup system including the lens apparatus 110 and the camera body 120. The camera CPU 122 is formed of a microcomputer, and is configured to control operation of components in the camera body 120. Further, the camera CPU 122 is configured to perform communication to/from the lens CPU 112 included in the lens apparatus 110 via an electrical contact 111 and an electrical contact 121 when the lens apparatus 110 is attached. Information transmitted to the lens CPU 112 by the camera CPU 122 includes information on a driving amount of a focus lens. Further, information transmitted from the lens CPU 112 to the camera CPU 122 includes image pickup magnification information, for example. The electrical contact 111 and the electrical contact 121 include a contact for supplying power from the camera body 120 to the lens apparatus 110. A power switch 123 is a switch operable by a photographer, and is operated to start the camera CPU 122, and start supplying power to actuators and sensors, for example, in the image pickup system.

Control of the camera body 120 is described first. A release switch 124 is a switch operable by the photographer, and includes a first stroke switch SW1 and a second stroke switch SW2. A signal from the release switch 124 is input to the camera CPU 122, and the camera CPU 122 enters a photography preparation state in response to an ON signal input from the first stroke switch SW1. In the photography preparation state, measurement of an object brightness by a photometer 125 and focus detection by a focus detector 126 are performed. The camera CPU 122 is configured to calculate an aperture value of an aperture unit (not shown) mounted in the lens apparatus 110, and an exposure amount (shutter time in seconds) of the image pickup element 6, for example, based on a photometry result. The camera CPU 122 is also configured to determine, based on focus information of the imaging optical system 1 obtained by the focus detector 126 of the camera CPU 122, the driving amount of the focus lens (not shown) for obtaining a state of being focused on an object. The information on the driving amount of the focus lens is transmitted to the lens CPU 112. The lens CPU 112 is configured to control operation of components of the lens apparatus 110. The camera CPU 122 is further configured to start controlling an image stabilization operation of the image blur correction device 30, 230 when a predetermined photography mode is set.

When an ON signal from the second stroke switch SW2 is input, the camera CPU 122 transmits, to the lens CPU 112, an aperture driving instruction, and sets the aperture unit to the aperture value calculated as described above. The camera CPU 122 also transmits, to an exposure unit 127, an instruction to start exposure so that the exposure unit 127 performs an operation of allowing the quick return mirror 2 to retreat and an operation of opening a shutter (not shown), to thereby perform an operation of exposing the object image in an image pickup unit 128 including the image pickup element 6. An image pickup signal from the image pickup unit 128 is converted into a digital signal in a signal processing unit in the camera CPU 122, and is further subjected to various kinds of correction processing to be output as an image signal. Image signal data is written and stored in a semiconductor memory, for example, a flash memory, or a recording medium, for example, a magnetic disk or an optical disc in an image storage unit 129.

Next, control of the lens apparatus 110 is described. A zoom operation amount detector 113 is configured to detect rotation of a zoom ring (not shown) with a sensor (not shown). An MF operation amount detector 114 is configured to detect rotation of a manual focus ring (not shown) with a sensor (not shown). An image blur correction device driver 115 includes an actuator configured to drive the image blur correction device 30, 230 and a drive circuit for the actuator. An electromagnetic aperture driver 116 is configured to set, by the lens CPU 112 that has received the aperture driving instruction from the camera CPU 122, the aperture unit to an aperture state corresponding to the aperture value. A focusing driver 117 is configured to drive the focus lens by a focusing drive mechanism (not shown) in response to the information on the driving amount of the focus lens transmitted from the camera CPU 122.

An angular velocity detector 118 includes an angular velocity sensor (not shown), and is configured to detect a shake in a pitch direction (vertical rotation) and a shake in a yaw direction (horizontal rotation), which are angular shakes, by the angular velocity sensor to output angular velocities of the angular shakes to the lens CPU 112. The lens CPU 112 is configured to integrate angular velocity signals in the pitch direction and the yaw direction from the angular velocity sensor to calculate angular displacement amounts in the respective directions. Then, the lens CPU 112 controls the image blur correction device driver 115 in accordance with the above-mentioned angular displacement amounts in the pitch direction and the yaw direction, and moves the lens L2 of the image blur correction device 30, 230 by shifting in the longitudinal direction and the lateral direction, to thereby perform the image blur correction.

The image pickup apparatus 100 (image pickup system) consists of the camera body 120 including the image pickup element 6 configured to receive light from the lens apparatus 110, and the lens apparatus 110 detachably attached to the camera body 120. However, the present disclosure is not limited thereto. The camera body 120 and the lens apparatus 110 may integrally form an image pickup apparatus 100, or a mirrorless single-lens reflex camera without the quick return mirror 2 may be adopted.

According to this application example, the lens apparatus 110 capable of suppressing the reduction in image quality caused when the image blur correction device 30, 230 is driven, and the image pickup apparatus 100 using the lens apparatus 110 can be provided.

The exemplary embodiments of the present disclosure are described above, but the present disclosure is not limited to those embodiments and can be modified and changed variously within the scope of the gist thereof.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-004426, filed Jan. 15, 2020, which is hereby incorporated by reference herein in its entirety.

What is claimed is:

1. A lens apparatus comprising:
a holding member configured to hold an optical element;
coils configured to move the holding member during image blur correction;
a supporting member which is made of a non-magnetic conductive material, and is configured to support the coils; and
a non-magnetic conductive member including:
a first portion located on one side of the coils in a direction of an optical axis of the optical element; and
a second portion located on one side of each of the coils in a direction perpendicular to the optical axis,
wherein the supporting member is adjacent to the coils on another side of the coils in the direction perpendicular to the optical axis.

2. The lens apparatus according to claim 1, wherein a part of the supporting member and a part of the first portion overlap each other when viewed from the direction of the optical axis.

3. The lens apparatus according to claim 1, wherein a part of the supporting member and a part of the first portion are opposed to each other in the direction of the optical axis.

4. The lens apparatus according to claim 1, wherein the first portion and the second portion are formed integrally with each other.

5. The lens apparatus according to claim 1, wherein the first portion and the second portion are formed separately from each other.

6. The lens apparatus according to claim 1, wherein the supporting member is located on an opposite side of the optical axis with respect to the coils in the direction perpendicular to the optical axis.

7. The lens apparatus according to claim 1, wherein the second portion includes:
a part located on one side in a longitudinal direction of each of the coils; and
a part located on one side in a lateral direction of each of the coils.

8. The lens apparatus according to claim 1, further comprising:
a fixing member configured to support the holding member; and
magnets held by the fixing member,
wherein the coils are held by the holding member.

9. The lens apparatus according to claim 1, wherein the coils are driven by pulse width modulation to move the holding member.

10. An image pickup apparatus comprising:
a holding member configured to hold an optical element;
coils configured to move the holding member during image blur correction;
a supporting member which is made of a non-magnetic conductive material, and is configured to support the coils; and
a non-magnetic conductive member including:
a first portion located on one side of the coils in a direction of an optical axis of the optical element; and
a second portion located on one side of each of the coils in a direction perpendicular to the optical axis,
wherein the supporting member includes:
a lens apparatus that is adjacent to the coils on another side of the coils in the direction perpendicular to the optical axis; and
an image pickup element configured to receive light from the lens apparatus.

11. An image pickup system comprising:
a holding member configured to hold an optical element;
coils configured to move the holding member during image blur correction;
a supporting member which is made of a non-magnetic conductive material, and is configured to support the coils; and
a non-magnetic conductive member including:
a first portion located on one side of the coils in a direction of an optical axis of the optical element; and
a second portion located on one side of each of the coils in a direction perpendicular to the optical axis,
wherein the supporting member includes:
a lens apparatus that is adjacent to the coils on another side of the coils in the direction perpendicular to the optical axis; and
an image pickup apparatus to which the lens apparatus is detachably attached.
